(19) United States
(12) Patent Application Publication
(10) Pub. No.: US 2024/0221968 A1
(43) Pub. Date: Jul. 4, 2024

(54) METHOD FOR PRODUCTION OF ACTINIUM-225

(71) Applicant: BWXT Medical Ltd., Ottawa (CA)

(72) Inventors: Patrick CAUSEY, Kanata (CA); Blake TAMBOLINE, Vancouver (CA); Michael WONG, Vancouver (CA); Alexander K. LEE, Vancouver (CA)

(21) Appl. No.: 18/397,136

(22) Filed: Dec. 27, 2023

Related U.S. Application Data
(60) Provisional application No. 63/435,883, filed on Dec. 29, 2022.

(51) Int. Cl. G21G 1/00

(52) U.S. Cl. CPC G21G 1/001; G21G 2001/0089

(57) ABSTRACT

A method for producing Actinium-225 from proton spallation of thorium targets via a radium generator. The method includes dissolving a thorium target into a thorium solution, evaporating the thorium solution thereby resulting in a dried thorium salt, reconstituting the dried thorium salt in sulfuric acid for formation of neutral thorium species, passing neutral thorium species through a cation exchange chromatography column for bulk thorium removal, conducting extraction chromatography in a mixed resin bed thereby eluting radium, evaporating the radium containing eluent, reconstituting dried radium, and conducting extraction chromatography to elute a purified radium fraction thereby constructing a radium generator.

### CROSS-REFERENCE TO RELATED APPLICATION

This application claims priority from U.S. Provisional Patent Application No. 63/435,883 filed on Dec. 29, 2022, in the United States Patent and Trademark Office. The disclosure of which is incorporated herein by reference in its entirety.

### FIELD OF THE INVENTION

The present invention relates to a method for producing Actinium-225, more particularly to a method for producing Actinium-225 from proton spallation of natural thorium targets via a radium generator.

### BACKGROUND OF THE INVENTION

There are existing processes for isolation and recovery of isotopes of radium and actinium. However, there are limitations associated with such methods. For example, in a report by Mastren et. al., (“Simultaneous Separation of Actinium and Radium Isotopes from a Proton Irradiated Thorium Matrix.” Scientific Reports 7, no. 1 (Aug. 15, 2017): 8216) there is a required step for conversion from hydrochloric acid solution to a citric acid solution prior to the application of a radiochemical separation step by cation exchange chromatography. This step is both time consuming and requires careful control of solution chemistry (pH and citrate concentration) in order to complex the dissolved bulk thorium, and avoid unwanted precipitation or incompatibility of some radionuclides present in solution on the cation exchange column. Due to the limited column sizing, which itself is a function of thorium capacity, retention of microgram quantities of bulk thorium introduces the possibility of column saturation, thereby resulting in loss of preferred elements of radium and actinium to the waste streams.

Thus, there is a need for a method that is a significant improvement over the existing chromatography processes and that eliminates the need for elaborate pH control to ensure complexation to prevent column retention of bulk thorium and simplifies the separation of bulk thorium from tracer quantities of preferred radioisotopes of radium and actinium.

In a report by Robertson et. al. (“232Th-Spallation-Produced 225Ac with Reduced 227Ac Content.” Inorganic Chemistry 59, no. 17 (Sep. 8, 2020): 12156-65. https://doi.org/10.1021/acs.inorgchem.0c01081), separation remains focused on isolation of actinium and radium. However, in this example, of note is the required step of precipitation for the removal of bulk thorium, in the form of insoluble thorium peroxide. This step is extremely time consuming and is operationally challenging, requiring careful manual control of a liquid suspension in order to precipitate the bulk thorium, and avoid unwanted co-precipitation of target isotopes and employs minimal co-precipitation of preferred radioisotopes to be successful. This process retains the need for chromatographic separation of radium and actinium from a plethora of other co-produced elements, and primarily achieves this by washing with controlled citrate solutions.

Thus, there is a need for a method that overcomes the disadvantages of these known methods.

### SUMMARY OF THE INVENTION

The present invention relates to a radiochemical separation method for producing Actinium-225 (Ac-225) from proton spallation of natural thorium targets via a radium generator.

In a feature of the present invention, the method for producing Actinium-225 via a radium generator generally comprises: dissolving a thorium target into a thorium solution; evaporating the thorium solution thereby resulting in a dried thorium salt; reconstituting the dried thorium salt in sulfuric acid for formation of neutral thorium species; passing neutral thorium species through a cation exchange chromatography column for bulk thorium removal; and conducting extraction chromatography in a mixed resin bed thereby eluting radium. The radium generator contains multiple radium isotopes. The multiple radium isotopes are selected from the group consisting of radium-223, radium-224, radium-225, radium-226, radium-227, radium-228, and a combination thereof.

In a feature of the present invention, the method for producing Actinium-225 generally comprises: dissolving a thorium target into a thorium solution; evaporating the thorium solution thereby resulting in a dried thorium salt; reconstituting the dried thorium salt in sulfuric acid for formation of neutral thorium species; passing neutral thorium species through a cation exchange chromatography column for bulk thorium removal; conducting extraction chromatography in a mixed resin bed thereby eluting radium; evaporating the radium containing eluent; reconstituting dried radium; and conducting extraction chromatography to elute a purified radium fraction thereby constructing a radium generator.

In a feature of the present invention, the method for producing Actinium-225 generally comprises: dissolving a thorium target into a thorium solution; evaporating the thorium solution thereby resulting in a dried thorium salt; reconstituting the dried thorium salt in sulfuric acid for formation of neutral Th(SO₄)₂; passing neutral Th(SO₄)₂ through a cation exchange chromatography column for bulk thorium removal; conducting extraction chromatography in a mixed resin bed thereby eluting radium; evaporating the radium containing eluent; reconstituting dried radium; and conducting extraction chromatography to elute a purified radium fraction thereby constructing a radium generator.

In a feature of the present invention, the method of the present invention comprises natural thorium dissolution, evaporation, and reconstitution of dried thorium salt into an acidic aqueous solvent. In the method, dried thorium salts are reconstituted, containing all other elements (both stable and radioactive), in dilute sulfuric acid. This allows for the in situ formation of neutral Th(SO₄)₂. This species can subsequently pass directly through the cation exchange column, thereby providing a path to the primary separation goal of removing the bulk thorium content from the target trace radioisotopes.

While in the presence of sulfate anions, radium species are immobilized on the cation exchange resin material, not passing through the column during loading nor washing steps. Washing steps remove some other unwanted impurities, while not removing the retained Ra²⁺ ions.

Next, the elution of mobilized radium species is realized by high molarity nitric acid, which will simultaneously contain varying quantities of many other problematic impurities. In order to specifically address these impurities (and others), the elution solution is then passed through a series of extraction chromatography resins intended to selectively remove those impurities, allowing radium isotopes to pass through unretained. Construction of the purified radium generator is realized by inclusion of a second, smaller cation exchange resin that is introduced to help remove residual +3 radiometals, along with a controlled citrate washing step to separate out other alkaline metals, in the absence of microquantities of thorium species. The formed generator can contain one or more radium isotopes, including radium-223, radium-224, radium-225, radium-226, radium-227 and radium-228. The radium generator is then stored to allow for ingrowth of Ac-225 from decay of Ra-225.

Milking of the radium generator is accomplished using a series of extraction chromatography resins leading to the production of polished, high purity, high activity clinical grade actinium-225.

Among the advantages of the method of the present invention include, but are not limited to, simplicity of the processing flow as demonstrated by the removal of any precipitation steps or complexing with pH-sensitive organic chelates such as citric acid. Other advantages include, but are not limited to, improved processing speed by not having operationally challenging precipitation steps as crucial to bulk thorium removal. The process as presented can be readily scaled if the input thorium mass is increased, and is not impacted by processing targets having higher irradiation doses. The minimal waste volume is readily collected in series and can be combined to undergo a waste volume reduction step by evaporation, which again can be scaled. The method of the present invention is a more efficient process resulting in a significant improvement in overall product yield because of the nature of radioactive decay.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a process diagram of a method in accordance with an embodiment of the present invention.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

The method of the present invention is for radiochemical separation. The method produces a radium generator from an irradiated thorium source for the purpose of producing high quality Actinium-225 (Ac-225), a therapeutic radioisotope. A radium generator is a radionuclide device that produces a short-lived medical radionuclide (known as “daughter”) from the radioactive transformation of a longer-lived radionuclide (called a “parent”). The generator permits ready separation of the daughter radionuclide from the parent. The generator device (sometimes referred to as a “cow”) typically provides opportunity for repeated separations of the daughter product. This separation process is called an elution (also referred to as a “milking”).

With the method of the present invention, a radium generator can be radiochemically isolated with minimal bulk thorium content, and with essentially no Ac-227 presence. The method of the present invention is highly effective for quickly and efficiently constructing a radium generator that is capable for subsequently producing high quality Ac-225, particularly suitable for therapeutic use.

The method of the present invention comprises the steps performed in the construction of the radium generator and the “milking” of the generator.

The method of the present invention generally comprises: (1) target dissolution; (2) target solution evaporation; (3) reconstitution; (4) cation exchange chromatography; (5) extraction chromatography; (6) eluent evaporation; (7) reconstitution; (8) extraction chromatography. The method may further comprise subsequent milking steps.

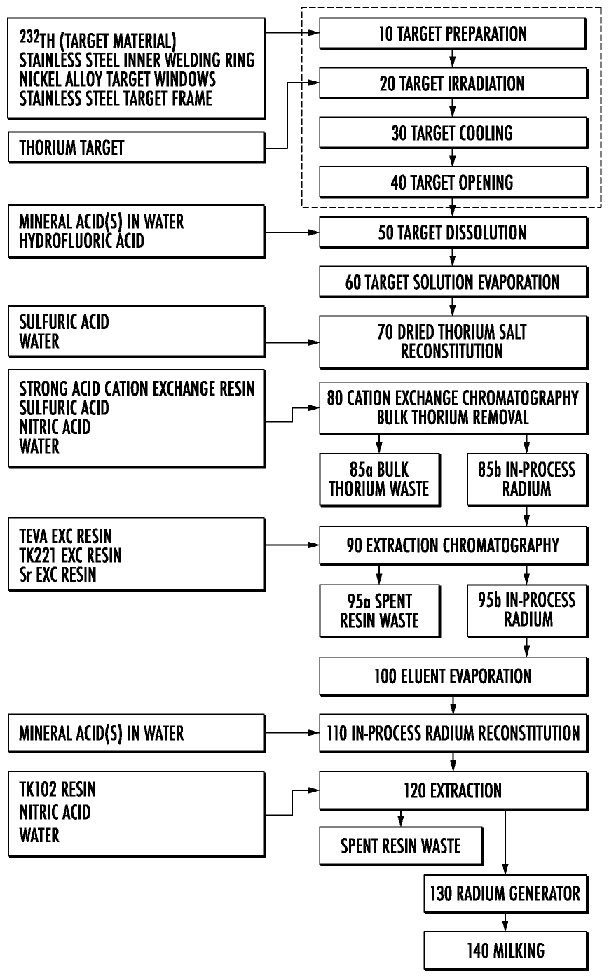

Prior to target dissolution, the method comprises obtaining an irradiated thorium target. Referring to FIG. 1, the processing steps to arrive at an irradiated thorium target (shown in dashed lines) may include target preparation 10 such as from 232Th metal as the target material using, for example, a stainless steel inner welding ring, nickel alloy target windows, and a stainless steel target frame. Target irradiation 20 follows target preparation 10. An encapsulated thorium target is irradiated with a current resulting in a complex but repeatable combination of nuclear spallation reactions. These reactions generate a diverse mixture of nearly every element on the periodic table up to element uranium in varying quantities, many of which are radioactive and will decay based on their respective isotopic properties. Formed nuclear reaction by-products are contained in the metal matrix, until they are released by target dissolution.

As shown in FIG. 1, Target dissolution 50 is readily accomplished using a high concentration of mineral acids in water including, for example, the oxidizing nitric acid. In order to accelerate the reaction to oxidize and dissolve the solid thorium metal target and all spallation by-products, a catalytic quantity of aqueous hydrofluoric acid is added.

Upon successfully dissolving the spallation targets, there is conversion of the liquid phase. This is recommended as there is a high concentration of solvating ions in solution and this step can be used to reduce the quantity of waste. As such, the method comprises target solution evaporation 60 of the thorium solution at elevated temperature. This is a process step for generating a soluble thorium salt species without the interfering presence of mineral acids like nitric or hydrochloric acid. Evaporation in reasonable time can be achieved at elevated temperatures, with or without reduced pressure, as produced under vacuum. Some care must be applied when evaporating at elevated temperatures to avoid the concomitant formation of thorium halides having negligible solubility, such as thorium tetrafluoride or thorium tetrachloride.

As shown in FIG. 1, the method comprises dried thorium salt reconstitution 70. The reconstitution or redissolution of the resultant thorium salts from the preceding steps involves the introduction of low concentration sulfuric acid. The realization of dilute sulfuric acid as the reconstitution solvent ensures that the bulk thorium remains in solution, albeit in a neutralized, but dissolved form of Th(SO₄)₂, due to the electrostatically driven interaction between thorium cations and sulfate anions. The solubility of this formed species is sufficiently high to prevent the unwanted precipitation of thorium out of solution, and can further help solubilize other cationic species present in sub-microgram quantities.

Upon reconstitution, the solution is loaded onto a sufficient quantity of cation exchange resin to separate the desired radium from as many other elements as possible, but importantly from the bulk thorium material, in cation exchange chromatography 80. Based on the trace masses of the different elements present, the overwhelming bulk of material is thorium, which can significantly impact the mobilization of radium. The invention here greatly simplifies the use of sulfate complexation to generate thorium species that are neutral in charge and are readily separated from radium species. As such, cation exchange chromatography 80 is primarily employed to separate complexed, neutral bulk thorium sulfate from tracer quantities of radium immobilized on the cation exchange resin. This step further separates other, unwanted spallation by-products, including most +4 metals and some +3 metals, depending on other chemical complex characteristics. The innovative step applied here has bulk, neutral Th(SO₄)₂ passing directly through the cation exchange resin, while Ra does not move through the chromatography column with the mobile phase, possibly due to high retention by the sulfonic acid functionalities of the resin, or possibly due to microprecipitation due to the limited Ra(SO₄) solubility in solution. Regardless, the separation of tracer quantities of radium from bulk thorium by cation exchange chromatography using sulfuric acid based mobile phases, which can be used without any additional pH or ionic concentration controls represents a significant process improvement, saving considerable time, being scalable for increased target masses, and applying a decontamination factor necessary to enable subsequent radiochemical steps in this process. This cation exchange chromatography 80 is completed by eluting radium, along with other alkaline metals and other lower valence transition metals, with high molarity nitric acid. This elution solution is suitable for extraction chromatography 90.

Following elution of radium 85b, along with some co-eluting impurities, the solution is directly passed onto a mixed bed of extraction chromatography resins in extraction chromatography 90. A non-limiting example of three resins employed are, from top to bottom, TEVA resin which contains organic extractants Aliquat-336, TK221 resin which is based on a mixture of diglocylamide and phosphine oxide (N,N,N′,N′-tetra-n-octyldiglycolamide/octyl(phenyl)-N,N-diisobutyl carbamoyl-methylphosphine oxide), and Sr resin (4,4′(5′)-di-t-butylcyclohexano 18-crown-6), with each resin performing a specific purification by removal of targeted impurities. Part of the innovation applied here involves the direct loading of the previous elution solution, onto a mixed bed that does not require repeated loading/eluting steps. The first resin the elution solution encounters is TEVA, which is an extraction chromatography resin containing the organic extractant Aliquat-336, which is an aliphatic quaternary ammonium chloride dissolved into an organic matrix that is then loaded onto an insoluble solid support. This extractant removes residual Th (IV) ions by the principles of liquid-liquid extraction. Even though bulk thorium was previously removed in by the cation resin, microscopic quantities are possible in solution and need to be removed in order to ensure that subsequent extraction chromatography resins are able to function as designed and are not capacity limited. Radium, along with other alkaline metals pass through to next resin, carried by the 7 M nitric acid mobile phase.

The next resin encountered is the TK221, an extraction chromatography resin available from TrisKem International. This resin contains a combination of extractants which work together for retention of +3 cationic ions, including actinium (III) and other lanthanides. The two combined extractants are alkyl-diglycolamides and phosphine oxides, both have individual application for +3 ions separations of lanthanides and also actinium, while simultaneously having improved radiation resistance. The TK221 resin is used to quantitatively remove all directly produced +3 ions still in solution, including any actinium, as direct production of actinium yields both the desired Ac-225 radioisotope, along with the long-lived impurity Ac-227.

Another extraction chromatography resin implemented in the mixed bed system is Sr resin, which contains di-t-butylcyclohexano-18-crown-6 extractant, which demonstrates very high affinity for the smaller ions from the Group 2, alkaline metals. Each of TEVA TK221 and Sr resins effectively remove many radioisotopes from the mid-molar nitric acid solution with negligible retention of radium isotopes. Performing these separations in a single reservoir significantly increases the speed and efficiency of the manufacturing process. These are among the significant advantages of this invention.

The method further comprises Eluent Evaporation 100. This step reduces the volume of the radium-containing solution, which is notable for the overall process due to the corresponding time needed for completing milking. Furthermore, larger mobile phase volumes necessitate larger resin volumes corresponding to a reduction in solid waste as a result of the radium fraction reduction.

Following the evaporation of the radium containing solution, radium reconstitution 110 of the dried residue is accomplished by low molarity mineral acid such as HCl and/or nitric. This solution is suitable for redissolving all metal salts and ensuring a homogeneous solution suitable for subsequent chromatographic separation steps, albeit with a significantly smaller volume which has the compounding benefit of reducing the size of the extraction chromatography resin employed in the next process step. This efficiency allows for quicker processing and reduced waste. Low molarity mineral acid is used for the quantitative release of all radium adsorbed onto the surface of the evaporation container into solution.

Following reconstitution 110, the solution is loaded onto an extraction chromatography 120 resin. On such example is TK102 from TrisKem International. The TK102 resin is based on the same crown-ether used in the SR resin while also containing a long-chained fluorinated alcohol as diluent. It was originally optimized for the separation of barium from radium. Barium species are retained on the resin, while radium species pass through directly, yielding the desired radium generator. This step targets the known impurity of Ba-140, which decays to La-140, an isotope having very similar chemistry to that of actinium, thereby impacting the radionuclidic purity of the final actinium material.

Following the successful construction of the radium generator by the removal of unwanted alkaline metals, the desired, purified radium fraction is stored. This fraction is suitable for intermediate storage as a radium generator 130, allowing for ingrowth of actinium-225 from decay of radium-225, followed by milking 140.

Milking 140 may comprise the following steps: extraction chromatography, dilution, and a subsequent extraction chromatography step(s) and final product evaporation.

Ingrowth of Ac-225 from decay of Ra-225 is simultaneously affected by the decay of Ac-225, allowing the generator system to reach equilibrium within a couple of weeks, however milking, or radiochemical separation of Ac-225 at earlier time points allows for increased overall production of the isotope. The first step in the milking procedure is the retention of all actinium isotopes onto the TK221 resin, when introduced at the prescribed mid-molar nitric acid concentration. The combination of n-akyldiglycolamides and phosphine oxides extractants composing the TK221 embedded organic phase serves to retain all +3 ions with the solid, or immobile phase. Radium present in solution passes directly through the resin with residual, nonspecifically bound +2 ions easily washed off in minimal volumes of mid-molar nitric acid. Release of the actinium, in advance of the release of any lanthanides, can be accomplished using a comparatively large volume of high molar nitric acid. Coupled with the favorable sizing for the TK221 resin, separated Ac-225 can be eluted in a manageable volume, suitable for further dilution, and additional extraction chromatography separation steps. The use of the TK221 represents a significant improvement due to the inclusion of the added extractant, phosphine oxide, resulting in improved separation of actinium from other +3 lanthanides.

As Ac-225 separation is accomplished by selective elution from lanthanide +3 cations using high molarity nitric acid, a dilution step is used in order to reduce the acidity and enable removal of trace radio impurities using targeted extraction chromatography. The dilution step involves addition of high purity water directly to the elution fraction to reduce the nitric acid molarity by half.

Following the dilution of the elution fraction, the mobile phase is passed through successive TEVA and Sr extraction chromatography resin. The TEVA resin contains the quaternary alkyl ammonium chloride extractant that complexes with highly cationic ions, like Ru (IV) and Th (IV), while not complexing with +3 ions. The Sr resin contains di-t-buylcyclohexano-18-crown-6 extractant that will effectively retain all alkaline ions when introduced in mid-molar nitric acid. The inclusion of a second extraction chromatography step is beneficial for the improved removal of trace impurities including Ru-103, a coproduced radio impurity that exists in multiple oxidation states (+3/+4) throughout the process, that results in challenges to the radiochemical separations. These polishing steps improve the radionuclidic purity without any loss of Ac-225, as this ion has negligible retention on either TEVA or Sr resins at this acidity; Ac-225 passes directly through without loss, before passing through the final extraction chromatography step.

In the final polishing step, the dilute actinium solution is passed through a terminal, small volume TK221 resin to retain and subsequently concentrate the Ac-225 through initial retention followed by elution in a low volume of dilute mineral acid. This eluted solution will have an improved activity concentration and is then suitable for quality control sampling and product dispensing.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method for producing Actinium-225 via a radium generator, the method comprising:
dissolving a thorium target into a thorium solution,
evaporating the thorium solution thereby resulting in a dried thorium salt,
reconstituting the dried thorium salt in sulfuric acid for formation of neutral thorium species,
passing neutral thorium species through a cation exchange chromatography column for bulk thorium removal, and
conducting extraction chromatography in a mixed resin bed thereby eluting radium.

2. The method according to claim 1, wherein the radium generator contains multiple radium isotopes.

3. The method according to claim 2, wherein the multiple radium isotopes are selected from the group consisting of radium-223, radium-224, radium-225, radium-226, radium-227, radium-228, and a combination thereof.

4. The method according to claim 1, wherein the radium generator is stored to allow for ingrowth of Ac-225 from decay of Ra-225.

5. A method for producing Actinium-225, the method comprising:
dissolving a thorium target into a thorium solution,
evaporating the thorium solution thereby resulting in a dried thorium salt,
reconstituting the dried thorium salt in sulfuric acid for formation of neutral thorium species,
passing neutral thorium species through a cation exchange chromatography column for bulk thorium removal,
conducting extraction chromatography in a mixed resin bed thereby eluting radium,
evaporating the radium containing eluent,
reconstituting dried radium, and
conducting extraction chromatography to elute a purified radium fraction thereby constructing a radium generator.

6. The method according to claim 5, further comprising milking.

7. The method according to claim 6, wherein milking is accomplished using a series of extraction chromatography resins.

8. The method according to claim 5, wherein the radium generator contains multiple radium isotopes.

9. The method according to claim 8, wherein the multiple radium isotopes are selected from the group consisting of radium-223, radium-224, radium-225, radium-226, radium-227, radium-228, and a combination thereof.

10. The method according to claim 5, wherein the radium generator is stored to allow for ingrowth of Ac-225 from decay of Ra-225.

11. A method for producing Actinium-225, the method comprising:
dissolving a thorium target into a thorium solution,
evaporating the thorium solution thereby resulting in a dried thorium salt,
reconstituting the dried thorium salt in sulfuric acid for formation of neutral Th(SO₄)₂,
passing neutral Th(SO₄)₂ through a cation exchange chromatography column for bulk thorium removal,
conducting extraction chromatography in a mixed resin bed thereby eluting radium,
evaporating the radium containing eluent,
reconstituting dried radium, and
conducting extraction chromatography to elute a purified radium fraction thereby constructing a radium generator.

12. The method according to claim 11, further comprising milking.

13. The method according to claim 12, wherein milking is accomplished using a series of extraction chromatography resins.

14. The method according to claim 11, wherein the radium generator contains multiple radium isotopes.

15. The method according to claim 14, wherein the multiple radium isotopes are selected from the group consisting of radium-223, radium-224, radium-225, radium-226, radium-227, radium-228, and a combination thereof.

16. The method according to claim 11, wherein the radium generator is stored to allow for ingrowth of Ac-225 from decay of Ra-225.
